(19) United States
(12) Patent Application Publication
(10) Pub. No.: US 2026/0366198 A1
(43) Pub. Date: Nov. 19, 2026

(54) A FIBROUS MONOFILAMENT, A METHOD OF MANUFACTURING THEREOF, AND A FIBROUS MATERIAL

(71) Applicant: SPINNOVA OYJ, Jyväskylä (FI)

(72) Inventors: Pia VENTO, Jyväskylä (FI); Maiju PÖYSTI, Jyväskylä (FI)

(21) Appl. No.: 19/144,233

(22) PCT Filed: Dec. 27, 2023
(86) PCT No.: PCT/FI2023/050742

§ 371 Date: Jun. 27, 2025

(30) Foreign Application Priority Data
Dec. 29, 2022 (FI) 20226181

(51) Int. Cl. D01F 1/10; D01F 2/00; D01F 11/02

(52) U.S. Cl. CPC D01F 1/10; D01F 2/00; D01F 11/02; D10B 2401/021

(57) ABSTRACT

A fibrous monofilament having at least 50 wt. % of non-regenerated microfibrillar cellulose, a dispersing agent, at least one of: a natural wax, a thermoplast, a sizing agent, or a natural rubber; and a crosslinking agent. Further, a fibrous material having the fibrous monofilament as well as a method of manufacturing the fibrous monofilament are provided.

### TECHNICAL FIELD

This specification relates to a fibrous monofilament, products comprising the same as well as to a method of manufacturing the fibrous monofilament. Particularly, the specification relates to a fibrous monofilament with lowered water absorptivity and improved softness after several washing and drying cycles.

### BACKGROUND

Textile product applications nowadays often utilize synthetic materials, when aiming for lowered water absorption and/or water/moisture resistance. However, synthetic materials often ultimately originate from petroleum industry, one of the drivers of the climate change. Thus, there is a need for more sustainable alternatives based on natural fiber sources to be employed in textile industry. Natural fiber sources replacing unsustainable cotton have been introduced. However, measures for lowering water absorptivity of such sustainable natural fiber sources are needed.

### SUMMARY

A sustainable fibrous monofilament with lowered water absorptivity for use e.g. in textile applications is provided. The fibrous monofilament disclosed herein can be used to replace at least partly the nowadays used petroleum-based synthetic materials. In certain applications, the disclosed fibrous monofilament enables replacing unsustainable cotton. Still further, the production process of the fibrous monofilament disclosed herein is an environmentally friendly one, utilizing mild conditions and not employing any harmful substances. This is a significant benefit when compared to other cellulose-based fibers, such as viscose and Lyocell. The disclosed fibrous monofilament has lowered water absorptivity and improved softness after several washing and drying cycles.

According to an embodiment, a fibrous monofilament is provided. The fibrous monofilament comprises at least 50 wt. % of non-regenerated microfibrillar cellulose (MFC), a dispersing agent, at least one of the following: a natural wax, a thermoplast, a sizing agent, natural rubber; and a crosslinking agent.

According to another embodiment, a method of manufacturing a fibrous monofilament is provided. The method comprises forming an aqueous suspension comprising from 90 to 96 wt. % of water, and from 4 to 10 wt. % of dry matter including non-regenerated microfibrillar cellulose (MFC), dispersing agent, at least one of the following: a natural wax, a thermoplast, a sizing agent, natural rubber as water-based emulsion/dispersion; and a crosslinking agent, the dry matter comprising at least 50 wt. % of non-regenerated MFC. The method further comprises extruding the suspension into a monofilament and drying the monofilament.

According to yet another embodiment, a fibrous material is provided. The fibrous material comprises the fibrous monofilament as described above.

### BRIEF DESCRIPTION OF THE DRAWINGS

FIG. 1 shows a photograph illustrating comparison of visual appearance of the standard (non-hydrophobic) fibrous monofilament and of the fibrous monofilament disclosed herein containing a hydrophobic recipe as well as the hydrophobic surface finishing agent after three washing and drying cycles.

### DETAILED DESCRIPTION

The solution is described in the following in more detail with reference to some embodiments, which shall not be regarded as limiting.

The features recited in the embodiments of the description and in the claims are mutually freely combinable unless otherwise explicitly stated.

In the present disclosure the percentage values relating to an amount or share of raw materials are percentages by weight (wt. %) with respect to a dry monofilament, unless otherwise indicated.

Plant materials are built up by a matrix formed by cellulose fibers also containing lignin and hemicelluloses. The cellulosic fibers that form such a matrix are fibril bundles which in turn consist of microfibrils. Through a fibrillation process the cellulose fibers are separated into a three-dimensional network of microfibrils with a large surface area. These entangled fibrils are called microfibrillar cellulose (MFC). The width of entangled fibrils in MFC may be from 50 nanometers to 2 micrometers and length or longitudinal dimension may be from 100 nanometers to 500 micrometers, such as from 100 nanometers to 200 micrometers.

Within context of this disclosure, the method of manufacturing MFC is not limited. MFC may be produced from cellulose fibers using methods known within the art through high pressure, high temperature and high velocity impact homogenization, for instance. The homogenization process is used to delaminate or disintegrate the cell walls of the fibers and to liberate their sub-structural fibrils and microfibrils. Enzymatic and/or mechanical pre-treatments of wood fibers may also be used.

In the present disclosure expressions “non-regenerated cellulose” or “natural cellulose” refer to cellulose or cellulose fibrils or fibers that have not undergone chemical or physical modification of their macromolecular structure. Non-regenerated MFC as discussed herein is substantially non-regenerated and consists mainly of crystalline structure of cellulose I. Cellulose I may have structures I_{α} and I_{β}. Man-made cellulosic fibers commonly used in textile applications are regenerated and their crystalline structure is mainly other than cellulose I. Conversion of cellulose I to cellulose II (or other forms, like cellulose Ill or cellulose IV) is irreversible. Thus, these forms are stable and cannot be converted back to cellulose I.

Within context of this disclosure, cellulose may originate from any plant-based material. Plant-based raw material may be wood material or non-wood material. The wood material can be based on softwood tree, such as spruce, pine, fir, larch, Douglas-fir or hemlock, or on hardwood tree, such as birch, aspen, poplar, alder, eucalyptus or acacia, or on any mixture of above. The non-wood material may be as cotton, hemp, flax, sisal, jute, kenaf, bamboo, peat, or coconut. Non-wood based natural cellulose fibers may also be derived from agricultural residues, grasses, or other plant substances such as straw, leaves, bark, seeds, hulls, flowers, vegetables, or fruits. Woody plants have a good availability, small environmental burden and the quality of fiber is good. The above applies both to non-regenerated cellulose and also regenerated and processed forms of cellulose.

It is an aim of this disclosure to provide a sustainable natural fiber source with lowered water absorptivity for use e.g. in textile applications. The fibrous monofilament disclosed herein can be used to replace at least partly the nowadays used petroleum-based synthetic materials for example in insulation materials used in textile industry. Further, the disclosed fibrous monofilament enables replacing unsustainable cotton. Still further, the fibrous monofilament disclosed herein is produced in a more environmentally friendly manner when compared to other cellulose-based fibers, such as viscose and Lyocell. The disclosed fibrous monofilament has lowered water absorptivity and improved softness after several washing and drying cycles.

The term “fibrous monofilament” as used herein refers to a continuous length of individual fibrils grouped and extending generally along the longitudinal dimension of the cellulose monofilament. The fibrils are interlocked together in order to form a permanent monofilament structure. The monofilament cannot be opened or disassembled. Disintegration of fibrous monofilament yields only individual fibrils. The fibrous monofilament may comprise continuous length of several meters or kilometers. Individual fibrils of the fibrous monofilament are mainly oriented along length of the fibrous monofilament. Term “monofilament” refers to a single strand filament produced by extruding a polymer suspension. Fibrous monofilament may also be called a monofilament fiber.

The fibrous monofilament according to this disclosure comprises or consists of non-regenerated microfibrillar cellulose (MFC), a dispersing agent, a crosslinking agent, and at least one of the following: a natural wax, a thermoplast, a sizing agent and natural rubber.

According to an embodiment the dispersing agent, the natural wax, the thermoplast, the sizing agent, the natural rubber and/or the crosslinking agent is/are biobased and/or biodegradable. When the components of the fibrous monofilament are biobased and/or biodegradable, the biodegradability of the fibrous monofilament and the materials prepared therefrom may be improved. Biodegradability of a material means that greater than 90% of the original material is converted into CO₂, water and minerals by biological processes within 6 months.

The fibrous monofilament disclosed herein comprises at least 50 wt. % of non-regenerated MFC of the dry weight of the fibrous monofilament. Preferably, the amount of the non-regenerated MFC is from 50 to 95 wt. %. For example, the amount of the non-regenerated MFC in the fibrous monofilament may be from 60 to 95 wt. %, from 70 to 95 wt. %, from 80 to 95 wt. %, from 80 to 90 wt. %, or from 80 to 85 wt. %.

The dispersing agent is needed in the manufacturing process phase of the fibrous monofilament to improve separation of the MFC fibrils and to prevent their settling or clumping. The dispersing agent can be any anionic hydrophilic polymer. In an example, the dispersing agent is carboxymethyl cellulose (CMC) and/or anionic polyacrylamide (aPAM). Alternatively, the dispersing agent may be any of the following: hydroxyethyl cellulose (HEC), ethyl hydroxyethyl cellulose (EHEC), methyl cellulose (MC), hydroxypropyl methyl cellulose (HPMC), hydroxyethyl methyl cellulose (HEMC), methyl ethyl hydroxyethyl cellulose (MEHEC), hydroxypropyl cellulose (HPC), ethyl cellulose (EC) and starch, or any combination thereof. Dispersing agent may also have an effect on shear strength of the fibrous monofilament. aPAM may also function as a rheology modifier.

The MFC fibrils show extensive hydrogen bonding arising from the presence of surface hydroxyl groups. However, these hydroxyl groups also efficiently bind water molecules, thereby increasing moisture sensitivity and lowering wet strength of the materials comprising MFC. In order to reduce the moisture sensitivity of hydrophilic MFC, certain degree of hydrophobicity may be added by incorporating a hydrophobic component. Within context of this disclosure, the hydrophobicity is introduced with at least one of a natural wax, a thermoplast a sizing agent, and natural rubber.

The fibrous monofilament comprises at least one of a natural wax, a thermoplast, a sizing agent, and natural rubber.

Thermoplast or thermoplastic (material) refers to a polymeric material that becomes pliable or moldable at a certain elevated temperature and solidifies upon cooling.

Waxes include a diverse class of lipophilic organic compounds that are malleable solids near ambient temperatures. Waxes include higher alkanes and lipids, typically with melting points above about 40 degrees C. Waxes melt to give low viscosity liquids. Natural waxes refer to waxes produced by plants or animals. Natural waxes also include modified plant and animal waxes.

Sizing agents are substances that can be used in textile industry or papermaking to tune the absorption properties and wear characteristics of the products.

Natural rubber consists of polymers of isoprene, with minor impurities of other organic compounds. Natural rubber may be harvested from the rubber tree or others in the form of latex, which is then refined into the rubber. Besides being water-proof, natural rubber has a large stretch ratio and high resilience.

According to an embodiment, the amount of the natural wax, thermoplast, sizing agent and/or natural rubber is from 0.1 to 15 wt. %, for example from 0.1 to 10 wt. %, from 0.1 to 5 wt. %, from 0.5 to 5 wt. %, from 1 to 5 wt. % or from 1 to 2.5 wt. % of the dry weight of the fibrous monofilament. Effect of the natural wax, thermoplast, sizing agent and/or natural rubber is to lower the water absorptivity of the fibrous monofilament.

In manufacturing phase the natural wax, thermoplast, sizing agent and/or natural rubber is added to the suspension as a water-based emulsion. The water-based emulsion containing the natural wax, thermoplast, sizing agent and/or natural rubber may also be called water-based dispersion. The water-based emulsion comprises an emulsion stabilizer. Emulsion stabilizer may also be called an emulsifier. The emulsion stabilizer stabilizes the emulsion by reducing the interfacial tension. Examples of emulsion stabilizers include for example surfactants and solid particles, such as lignin nanoparticles. Lignin nanoparticles may be utilized as stabilizing agents via so-called Pickering emulsion strategy. Herein, the Pickering emulsion strategy may allow even dispersion of the natural wax, thermoplast, sizing agent and/or natural rubber onto the MFC network.

An example of sizing agents suitable for the fibrous monofilament disclosed herein is an alkyl ketene dimer (AKD). Besides lowering the water absorption properties of the fibrous monofilament, AKD may further increase strength of the fibrous monofilament.

Examples of thermoplasts suitable for the fibrous monofilament disclosed herein include for example polybutylene adipate terephthalate (PBAT) and poly(butylene succinate-co-butylene adipate) (PBSA). Further, thermoplastic natural rubber, which refers to a thermoplastic material produced on blending thermoplastic with natural rubber, may also be considered. Still further, PBAT blended with polylactic acid (PLA) may be used.

Examples of suitable natural waxes for the fibrous monofilament disclosed herein include for example beeswax, carnauba wax and rice bran wax.

The hydrophobicity introduced with at least one of a natural wax, a thermoplast a sizing agent, and natural rubber has the effect of decreasing intermolecular and intramolecular hydrogen bonding of MFC, thereby providing water repellency as well as enabling maintenance of soft and fluffy appearance of the fibrous monofilament when dried after wetting.

The fibrous monofilament comprises a crosslinking agent, for example a wet strength agent. According to an embodiment, the amount of the crosslinking agent is from 1 to 6 wt. %, such as from 2 to 5 wt. % of the dry weight of the fibrous monofilament. In an example, the crosslinking agent is a polyamidoamine-epichlorohydrin (PAE) resin. PAE provides improved wet strength properties such as wet tenacity and elongation to the fibrous monofilament. PAE may also prevent shrinkage and improve wet abrasion resistance.

According to an embodiment, the fibrous monofilament further comprises an amino-functional component, such as chitosan. The amino-functional component refers to a (polymer) component having free amino group(s). Chitosan is a linear polysaccharide composed of randomly distributed β-(1→4)-linked D-glucosamine (deacetylated unit) and N-acetyl-D-glucosamine (acetylated unit). Chitosan is produced commercially by deacetylation of chitin, which is a structural element in the exoskeleton of crustaceans and cell walls of fungi. Degree of deacetylation (% DD) in commercial chitosan ranges from 60 to 100%. Chitosan has the effect of lowering water absorption. Further, it also enables maintaining the fibrous monofilament fluffy after washing and subsequent drying. Amount of the amino-functional component, such as chitosan may for example be from 0.5 to 5 wt. %, such as from 1 to 3 wt. % of the dry weight of the fibrous monofilament.

The fibrous monofilament comprising besides non-regenerated MFC, also a dispersing agent, at least one of the following: a natural wax, a thermoplast, a sizing agent and natural rubber; as well as a crosslinking agent shows lowered water absorption that may as such be sufficient for certain applications. However, for applications wherein even lower water absorptivity is desired, the fibrous monofilament may further comprise a hydrophobic surface finishing agent.

For example, the hydrophobic surface finishing agent may be a fluorine-free agent, such as a silicone-based agent or a long-chain hydrocarbon. Within context of this disclosure, long-chain hydrocarbon refers to a hydrocarbon having at least 10 carbon atoms. The hydrophobic surface finishing agent may be biobased and/or biodegradable.

According to an exemplary embodiment, the fibrous monofilament comprises at least 50 wt. % of non-regenerated microfibrillar cellulose, CMC as a dispersing agent, PAE resin as a crosslinking agent and AKD.

Besides the dispersing agent and the crosslinking agent, the fibrous monofilament may comprise additional polymeric additive(s). For example, the fibrous monofilament may comprise a plasticizer. The plasticizer may be for example polyethylene oxide (PEO).

According to an embodiment, the fibrous monofilament disclosed herein shows a water absorption (Wa) of at most 200%, or at most 150%, or even at most 100%, when measured according to EN 13543-2001. At best, a water absorption of about 50% can be achieved. The water absorption test determines the capacity of water absorption of a (filling) material as it is submerged in water for one hour under specific conditions detailed in EN 13543-2001. For natural fiber-based material the water absorption of at most 200% is good, of at most 100% is extremely good. For reference, synthetic polyester fiber-based materials may have a water absorption of about 50%.

The fibrous monofilament according to this disclosure may have a density of between 500 and 2000 kg/m³, for example between 1000 and 1700 kg/m³, such as about 1500 kg/m³.

For manufacturing of the fibrous monofilament an aqueous suspension comprising water, non-regenerated microfibrillar cellulose (MFC), dispersing agent, at least one of the following: a natural wax, a thermoplast, a sizing agent, natural rubber; and a crosslinking agent is formed. The natural wax, thermoplast, sizing agent and/or natural rubber is added to the suspension as a water-based emulsion/dispersion. The water-based emulsion/dispersion also comprises an emulsion stabilizer. The aqueous suspension comprises from 90 to 96 wt. % of water, and from 4 to 10 wt. % of dry matter including non-regenerated MFC, dispersing agent, at least one of the following: a natural wax, a thermoplast, a sizing agent, natural rubber; and a crosslinking agent. Of the dry matter content, at least 50 wt. % is non-regenerated MFC.

Usual order of adding the components (added to an aqueous solution) to form the aqueous suspension is MFC, crosslinking agent, dispersing agent and at least one of the following: a natural wax, a thermoplast, a sizing agent, natural rubber as water-based emulsion/dispersion. Alternatively, the dispersing agent may be added right after MFC.

The aqueous suspension is directed through a small nozzle (extruded) where fibers align (orient) well with the flow. The nozzle feeds the aqueous suspension to a solid surface which is followed by drying to obtain the fibrous monofilament.

Initial fibril orientation of the fibrous monofilament may be achieved during the extrusion phase. A nozzle having an outer diameter smaller than or equal to the maximum fibril length of the fibers causes the fibrils to orientate substantially in the longitudinal direction of the suspension exiting the nozzle. Fibril orientation along the longitudinal direction of the fibrous monofilament provides strength to the filament.

Manufactured fibrous monofilament is continuous but it may be post processed into shorter lengths by any of suitable methods known in the art. Thickness of the fibrous monofilament may be affected at least in part by adapting manufacturing speed, aqueous suspension concentration and nozzle geometry.

Maintaining optimal pH in the suspension may play a role in the manufacturing process. Addition of PAE often strongly affects the suspension pH. For example, when adding 2 wt. % of PAE the pH may drop by one unit (e.g. from pH 6.5 to pH 5.5). For AKD the optimal operating window in terms of pH is from about 6.5 to highly alkaline. Therefore, when using PAE and AKD, it is recommended to adjust the pH of the suspension to a desired level after addition of PAE and before addition of AKD. The pH may be adjusted with a base, such as NaOH. Alternatively, a buffering solution may be utilized for maintaining the pH on desired level.

The method may further comprise introducing a hydrophobic surface finishing agent after drying the monofilament. The hydrophobic surface finishing agent may be introduced for example by at least one of the following: plasma coating, wet spray coating, dipping, impregnation, immersion and/or kiss roller coating. As already mentioned, the hydrophobic surface finishing agent may be a fluorine-free agent, such as a silicone-based agent or a long-chain hydrocarbon. The hydrophobic surface finishing agent typically has positive effect in wash durability of the fibrous monofilament. The hydrophobic surface finishing agent may be referred to as durable water repellent (DWR). In certain cases, the hydrophobic surface finishing agent may be arranged to be attached to the fibrous monofilament via covalent bonding. Covalent bonding may represent a wash proof manner of attaching the hydrophobic surface finishing agent.

The fibrous monofilament according to this disclosure finds use in fibrous materials, such as woven, knitted or non-woven materials or as composite materials. The fibrous monofilaments may be utilized for producing fiber or yarn for fibrous materials.

The fibrous materials may be manufactured by using any methods known in the art. For example, for non-woven materials for use in thermal insulation applications in textile industry, the fibrous monofilaments may be processed to fluffy spherical material clusters.

Textile product applications, such as clothes or sleeping bags for cold or cool environments typically employ thermal insulation materials. Nowadays, when choosing the insulation material, a major choice to be made is between down and synthetic filler. The excellent compressibility of down allows small pack sizes. Down is also highly resilient. However, down will lose its insulating power if the product gets wet. Synthetic filler is made from synthetic material that is designed to mimic the functions of down. Synthetic insulation will not be marred by moisture. Further, synthetic filler is much easier to maintain than down, and it is also more cost-effective. However, as already mentioned, the drawback of synthetic materials is that they often ultimately originate from petroleum industry, one of the drivers of the climate change.

The fibrous monofilament disclosed herein shows lowered water absorption when compared to a standard (non-hydrophobic) recipe used so far. Further, presence of post-wetting compressed structures within the material prepared from the monofilament is reduced. The materials remain fluffy and soft after drying, thereby being suitable for use as insulation materials for example in clothing. The fibrous monofilament as disclosed herein and/or a material prepared therefrom may be used for replacing synthetic polyester or polypropylene fiber nowadays used in insulation materials. At least 50 wt. % of the polyester/polypropylene fiber may be replaced with the fibrous monofilament and/or the material prepared from the fibrous monofilament disclosed herein.

The way clothing interacts with the user's body, particularly in respect of the dissipation of heat and moisture, plays a major role in the user's perceived comfort. The fibrous monofilament disclosed herein may be used in products capable of improving the user's sensory and thermal comfort. For example, the fibrous monofilament disclosed herein may be used to provide breathability to the product utilizing it. Breathability refers to dissipating heat and preventing water vapour (sweat) from building up, thereby providing more perceived user comfort. Further, thermal properties of the fibrous monofilament according to this disclosure have been shown to be on excellent level. The fibrous monofilament produced by extruding a polymer suspension is able to hold a significant amount of trapped air, therefore being able to give more thermal insulation. Materials comprising or consisting of the fibrous monofilament disclosed herein may be used in maintaining a balance of heat loss from the user's body and heat generation in the body to keep the user comfortable.

Wash durability of the material comprising or consisting of the monofilaments as disclosed herein has been tested by following a standard ISO 6330 using a 40 degrees C washing program. Based on the results, the water absorption and thereby the voluminous structure and softness of the material may remain on a desired level for at least three washing and drying cycles.

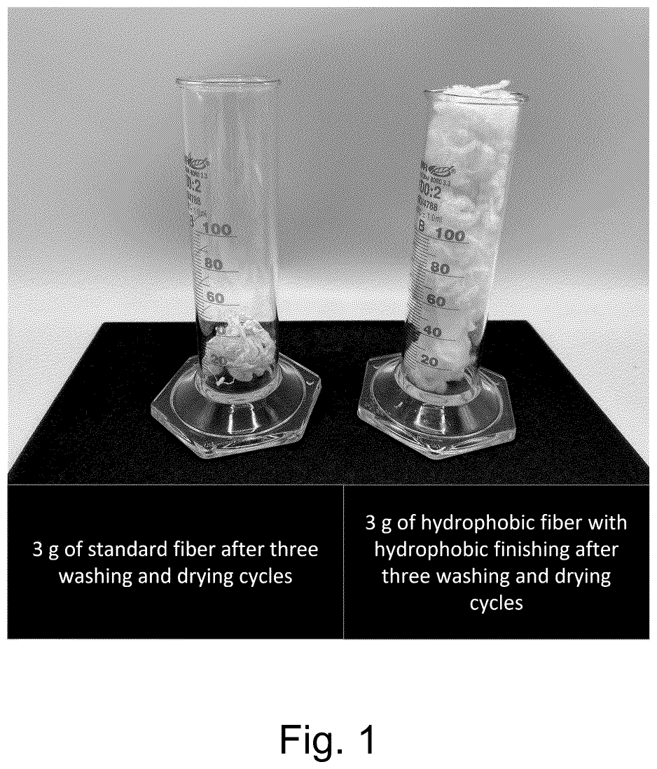

FIG. 1 shows a photograph illustrating comparison of visual appearance of 3 g of the standard (non-hydrophobic) fibrous monofilament and 3 g of the fibrous monofilament disclosed herein containing a hydrophobic recipe as well as a hydrophobic surface finishing agent after three washing and drying cycles. It is clearly seen that with the standard, non-hydrophobic recipe compressed, non-fluffy and paper-like structures are obtained after three washing and drying cycles. Presence of such compressed structures is undesired, since for example in thermal insulation applications the insulation capacity is lost when the material no longer exists in a fluffy, voluminous state being capable of trapping air into the structure. Further, in such compressed structures the softness of the material is diminished or even lost, thereby affecting the user comfort. Fill power is a measure of the “fluffiness” of a material that is loosely related to the insulating value of the material. The higher the fill power, the more air a certain weight of the material can trap, and thus the more insulating ability the material will have. Any insulation material provides warmth by trapping a layer of air that separates the cold side from the warm side. A thicker layer of trapped air gives more insulation. This thickness may be called “loft”. The material consisting of the fibrous monofilament according to this disclosure after three washing and drying cycles still has a fluffy, voluminous structure, wherein the softness of the material is preserved, thus showing desired wash durability.

### Examples

Exemplary fibrous monofilaments were prepared and their water absorption properties studied.

The fibrous monofilaments included from 80 to 85 wt. % of non-regenerated MFC as the main component. The non-regenerated MFC had a hemicellulose content of about 1-5 wt. % or about 12-17 wt. %. The fibrous monofilaments contained 1, 1.5 or 5 wt. % of AKD and 2 or 4 wt. % of PAE. CMC was used as a dispersing agent and aPAM as a rheology modifier.

Water absorption (Wa) of the (fiber) material comprising or consisting of the fibrous monofilaments was measured according to EN 13543-2001. For the above described monofilaments the average water absorption was shown to be from about 50% to about 200%, depending both on the hemicellulose content of the MFC as well as on the drying conditions of the fibrous monofilament. For reference, fibrous monofilaments prepared with a standard recipe including 0.5 wt. % of AKD and 2 wt. % of PAE showed an average water absorption of above 200%, such as from about 250% to about 850%, depending both on the chemical properties, such as hemicellulose content of the MFC as well as on the drying conditions of the fibrous monofilament. Generally, for the fibrous monofilament comprising MFC with higher hemicellulose content, higher water absorption values were observed.

Further, effect of chitosan on the water absorption of the (fiber) material comprising or consisting of the fibrous monofilament was studied. Monofilament compositions and measured average water absorptions of the materials studied are shown in Table 1.

TABLE 1

| | | Water |
|---|---|---|
| | | absorption |
| Sample | Composition | average (%) |
| S1 | 2.3 wt. % chitosan + 0.5 wt. % AKD | 260 |
| S2 | 2.3 wt. % chitosan + 0 wt. % AKD | 1005 |
| S3 | 1 wt. % chitosan + 0.5 wt. % AKD | 292 |
| S4 | 1 wt. % chitosan + 1 wt. % AKD | 144 |
| S5 | 1 wt. % chitosan + 1.5 wt. % AKD | 116 |

All of the samples S1-S5 contained from 80 to 85 wt. % of non-regenerated MFC having a hemicellulose content of about 12-17 wt. %. Further, the samples contained 2 wt. % or 3 wt. % of aPAM.

For reference, the standard recipe utilizing 0.5 wt. % of AKD with MFC having a hemicellulose content of about 12-17 wt. % showed average water absorption of about 650-850%. With the addition of 1 wt. % of chitosan, the average water absorption was only about 300%. The results thus show that chitosan even at low concentration together with AKD is able to lower the water absorption.

Regarding AKD, the experiments have shown that the amount of 0.5 wt. % of AKD is not alone enough to lower the water absorption to a desired level. However, when combined with a hydrophobic surface finishing agent the AKD amount of 0.5 wt. % is shown to be enough.

1. A fibrous monofilament comprising:
at least 50 wt. % of non-regenerated microfibrillar cellulose,
a dispersing agent,
at least one of: a natural wax, a thermoplast, a sizing agent, or a natural rubber; and
a crosslinking agent.

2. The fibrous monofilament according to claim 1, wherein the dispersing agent, the natural wax, the thermoplast, the sizing agent, the natural rubber and/or the crosslinking agent is biobased and/or biodegradable.

3. The fibrous monofilament according to claim 1, wherein the sizing agent is an alkyl ketene dimer.

4. The fibrous monofilament according to claim 1, wherein an amount of the natural wax, thermoplast, sizing agent and/or natural rubber is from 0.1 to 15 wt. %.

5. The fibrous monofilament according to claim 1, wherein an amount of the crosslinking agent is from 1 to 6 wt. %.

6. The fibrous monofilament according to claim 1, wherein the crosslinking agent is a polyamidoamine-epichlorohydrin resin.

7. The fibrous monofilament according to claim 1, further comprising an amino-functional component.

8. The fibrous monofilament according to claim 1, further comprising a hydrophobic surface finishing agent.

9. The fibrous monofilament according to claim 8, wherein the hydrophobic surface finishing agent is biobased and/or biodegradable.

10. The fibrous monofilament according to claim 8, wherein the hydrophobic surface finishing agent is a fluorine-free silicone-based agent or a fluorine-free long-chain hydrocarbon.

11. The fibrous monofilament according to claim 1, wherein the fibrous monofilament has a water absorption of at most 200% when measured according to EN 13543-2001.

12. A method of manufacturing a fibrous monofilament, the method comprising
forming an aqueous suspension comprising from 90 to 96 wt. % of water, and from 4 to 10 wt. % of dry matter including non-regenerated microfibrillar cellulose, a dispersing agent, at least one of: a natural wax, a thermoplast, a sizing agent, or a natural rubber as water-based emulsion/dispersion, and a crosslinking agent, the dry matter comprising at least 50 wt. % of non-regenerated microfibrillar cellulose,
extruding the suspension into a monofilament, and
drying the monofilament.

13. The method according to claim 12, further comprising
introducing a hydrophobic surface finishing agent after drying the monofilament.

14. The method according to claim 13, wherein the hydrophobic surface finishing agent is introduced by at least one of: plasma coating, wet spray coating, dipping, impregnation, immersion and/or kiss roller coating.

15. A fibrous material comprising the fibrous monofilament according to claim 1.

16. The fibrous monofilament according to claim 7, wherein the amino-functional component is chitosan.
